(19) United States
(12) Patent Application Publication
(10) Pub. No.: US 2003/0149690 A1
(43) Pub. Date: Aug. 7, 2003

(54) Method and apparatus to search domain name variations world wide

(76) Inventors: Mark E. Kudlacik, Hoboken, NJ (US); Mark Saltzman, Cambridge, MA (US)

Correspondence Address: MARK KUDLACIK, 307 Bloomfield St., Hoboken, NJ, 07030, US

(21) Appl. No.: 10/355,639

(22) Filed: Jan. 31, 2003

Related U.S. Application Data
(60) Provisional application No. 60/353,539, filed on Feb. 1, 2002.

(51) Int. Cl. G06F 7/00

(52) U.S. Cl. 707/3

(57) ABSTRACT

A method and apparatus for searching all public datbases, indexing the results such that a CCTLD and GTLD indication is deleted, searching the indexed results in all non-public zone files and generating results wherein the apparatus is comprised of a processor having access to the world wide web and memory having instructions that when executed by the processor cause the computer system to perform the steps above.

### CROSS REFERENCE

This application claims benefit of U.S. Application Serial No. 60/353,539, filed on Feb. 1, 2002.

### BACKGROUND OF THE INVENTION

1. Field of the Invention

This invention relates to a method and apparatus for searching domain names. More particularly, this invention relates to a method and apparatus for searching domain names in non-public files.

2. Description of Related Art

Domain names are the method by which the average individual navigates the Internet, and more specifically, the world wide web. Domain names convert a name, which is easily remembered by the public, to a numerical address that identifies a particular computer's Internet Protocol Address, which is actually a number typed through the computer by the end user. Each domain name is comprised of a unique string of letters and/or characters and correspondingly the Internet Protocol Address (“IP Address) is comprised of a unique string of numbers. This is analogous to how companies market telephone numbers such as ATT®, which advertises its 800 telephone number as “800 CALL ATT”® while the unique telephone number is actually 800-225-5288.

Domain names are maintained by jurisdictions, usually countries, as identified by ICANN (Internet Corporation for Assigned Names & Numbers). Each jurisdiction maintains its own registry of domain names. The domain names are all unique even to each country as the letter/character string is followed by, for example in the two letter designation for France, .fr, or for Germany, de. There are over 240 such country code jurisdictions identified by ICANN. For example, each string of letters, such as “att” may be registered separately in each country, such as “www.att.fr” and “www.att.de”. Each of these domain names is referred to as a Country Code Top Level Domain (“CCTLD”). Further, there are Generic Top Level Domains (“GTLD”) which are maintained by ICANN The GTLDs include .com, net, org, .info, .biz, mil, .edu, .gov, coop, museum, pro, name, and aero. Additional GTLDs are created as needed.

The list of domain names registered with a particular CCTLD or GTLD is controlled by that particular registry and is commonly referred to as the zone file. Some registries make their zone file data publicly available and downloadable on the Internet and other registries do not. Currently, about 50 percent of countries do not allow easy access to the domain name zone file data, which is the authoritative list of all domains that have been registered in that jurisdiction.

With a zone file properly indexed, a particular string of letters/characters is searchable not just for identical domain names, but also for variations of a domain name. For example, a properly indexed zone file would allow a query for all domain names beginning with “comp”, or for domain names containing the term “amazon” anywhere in the letter/character string. Such queries would retrieve derivative letter/character strings and/or terms like “www.compusa.com” or “www.myamazonbookstore.com”, respectively in addition to the exact match of “www.comp.com” and/or “www.amazon.com”.

Regardless of whether or not registries make their zone file data available, the registries make servers available that allow queries, commonly referred to as name server queries, to determine if a particular domain name is registered. This is done by sending a query to the name server and asking it if a unique character string is registered. As an example, this can be done using the Nslookup feature available in UNIX or other domain name resolution protocols. Because this method requires an exact character string be queried, it does not allow for any type of embedded or partial match text searching as described above. In the example above, the response to an NSLookup of “comp” and “amazon” would only yield the exact matches of the query (such as “www.comp.fr”) and not any embedded or derivative match (such as “www.compusa.fr”).

Saegis® by Thomson & Thomson has attempted to combat this problem without success in that their domain data is incomplete and has not been updated for some time. The following jurisdictions are listed by Thomson and Thomson as having incomplete or stale data:

| | |
|---|---|
| .af | Afghanistan |
| .al | Albania |
| .ad | Andorra |
| .aq | Antarctica |
| .aw | Aruba |
| .bs | Bahamas |
| .bh | Bahrain |
| .bd | Bangladesh |
| .bb | Barbados |
| .bw | Botswana |
| .bv | Bouvet Island |
| .br | Brazil |
| .io | British Indian Territory |
| .bn | Brunei Darussalam |
| .bf | Burkino Faso |
| .bi | Burundi |
| .cm | Cameroon |
| .ca | Canada |
| .ky | Cayman Islands |
| .cn | China |
| .co | Columbia |
| .km | Comoros |
| .cd | Congo (Dem. Rep.) |
| .cg | Congo |
| .ck | Cook Islands |
| .co | Ivory Coast |
| .cu | Cuba |
| .cz | Czech Republic |
| .dk | Denmark |
| .dj | Djibouti |
| .dm | Dominica |
| .do | Dominican Republic |
| .ec | Ecuador |
| .gq | Equatorial Guinea |
| .er | Eritrea |
| .et | Ethiopia |
| .fk | Falkland Islands |
| .fo | Faroe Islands |
| .fr | France |
| .gf | French Guyana |
| .tf | French Southern Territories |
| .de | Germany |
| .gh | Ghana |
| .gb | Great Britain |
| .gl | Greenland |
| .gd | Grenada |
| .gu | Guam |
| .gn | Guinea |
| .gw | Guinea Bissau |
| .gy | Guyana |
| .ht | Haiti |
| .hk | Hong Kong |
| .iq | Iraq |
| .il | Israel |
| .jp | Japan |
| .ke | Kenya |
| .ki | Kiribati |
| .kp | North Korea |
| .kr | South Korea |
| .kw | Kuwait |
| .kg | Kyrgystan |
| .la | Laos |
| .lv | Latvia |
| .lb | Lebanon |
| .ls | Lesotho |
| .lr | Liberia |
| .ly | Libya |
| .lu | Luxembourg |
| .my | Malaysia |
| .mv | Maldives |
| .ml | Mali |
| .mt | Malta |
| .mh | Marshall Islands |
| .mr | Mauritania |
| .yt | Mayotte |
| .mx | Mexico |
| .md | Moldova |
| .mn | Mongolia |
| .ma | Morocco |
| .mz | Mozambique |
| .mm | Myanmar (Burma) |
| .na | Namibia |
| .nr | Nauru |
| .np | Nepal |
| .ne | Niger |
| .nf | Norfolk Island |
| .no | Norway |
| .om | Oman |
| .pw | Palau |
| .pa | Panama |
| .py | Paraguay |
| .pt | Portugal |
| .pr | Puerto Rico |
| .re | Reunion |
| .lc | Saint Lucia |
| .vc | Saint Vincent and the |
| | Grenadines |
| .sn | Senegal |
| .sc | Seychelles |
| .sl | Sierra Leone |
| .sg | Singapore |
| .si | Slovenia |
| .sb | Solomon Islands |
| .so | Somalia |
| .su | Soviet Union |
| .sd | Sudan |
| .sj | Svalbard & Jan Mayen Islands |
| .sz | Swaziland |
| .sy | Syria |
| .tw | Taiwan |
| .tj | Tajikistan |
| .tg | Togo |
| .tk | Tokelau |
| .tt | Trinidad and Tobago |
| .tn | Tunisia |
| .tm | Turkmenistan |
| .um | U.S. Minor Outlying Islands |
| .ae | United Arab Emirates |
| .uk | United Kingdom |
| .us | United States |
| .vi | U.S. Virgin Islands |
| .va | Vatican City State (Holy See) |
| .vn | Vietnam |
| .wf | Wallis and Futuna Islands |
| .eh | Western Sahara |
| .zr | Zaire |
| .zm | Zambia |
| .zw | Zimbabwe |

Others have attempted to maintain a domain name search tool, but only searchable in jurisdictions that make zone file data available, by crawling the web for active web sites or by allowing for an identical search on a global basis.

A need exists for a method for searching all variations of a domain name in all jurisdictions, even those which do not make their zone file data available. Being able to search the domain data with various permutations allows a potential registrant to ensure that the domain name they are considering does not infringe or is not confusingly similar to any other domain names currently registered. By doing so, the domain registrant can avoid costly and lengthy trademark litigation, and can ensure that its consumers are not misled by the similarity of domain names. Having the power to perform such domain searches also ensures that companies do not expend capital promoting a domain name they will be forced to stop using because that domain name infringes the Intellectual Property rights of another domain name and/or trademark. Having this ability will allow companies and individuals to make better decisions in selecting domain names and will allow them to enforce their trademark and Intellectual Property rights against those who infringe those rights. Conversely, a method and apparatus to search and ensure a domain name is not dropped from a registry is needed to ensure that an individual's or company's own domain name is not accidentally deleted or to register a domain name that they were interested in but was previously unavailable.

Accordingly, there exists a need to search all variations of a letter/character string, be they prefix or suffix or a word contained in the middle the searched letter/character string, in any jurisdiction of interest. Such searches need to include any jurisdiction, not just those with readily available zone file searches.

### SUMMARY OF THE INVENTION

It has now been found that the objectives of this invention are realized by employing a method and apparatus for searching and identify domain names from countries that do not make their domain name zone file data readily available. The invention makes it possible to perform partial match queries on domain names from countries that do not make their domain name zone file data readily available.

The invention uses data mining techniques in the domain space by compiling databases combined with servers and a network of computers so as to search for registered domain names world wide.

It is an object of the invention to provide a search of currently registered domain names containing a certain letter/character string. Another object of the invention is to provide a search of currently registered domain names containing more than one letter/character string.

Another object of the invention is to provide a method for doing a search of all domain names and notifying an end user of newly identified domain names that match a predefined search criteria, thus creating a domain name watching tool.

### DETAILED DESCRIPTION OF THE INVENTION

According to the present invention it has been found that a method and apparatus can search domain names and their variations in any jurisdiction, regardless of zone file accessibility.

The method and apparatus collects all currently available public data in the world and downloads them onto a server of the apparatus. This publicly available data may include, but is not limited to information available on the world wide web and Internet, trademark lists, business lists and zone files.

It is realized that as public databases and zone files are created by different jurisdictions and available to the public they will be continuously downloaded into the system of the invention and updated. The system is updated weekly (though other updates periods are possible) from the already downloaded databases and files and any new zone files subsequently made available.

All of the downloaded domain names are indexed and gathered to allow the collected domain names to be searched as a prefix, suffix or mid-word. For example, this will allow searching all stored names on the server for all domain names beginning with “comp” or ending in “amazon”. By way of example, the systems allows for a user interface to allow the user to input search terms using the “*” key as a wildcard, such that “comp*” will search for all comp prefixes and “*amazon” will search for all amazon suffixes. Other search variations are also possible such as “*amazon*” which will locate all mid-word occurrences of amazon. Further, Boolean logic may be used to exclude certain terms or combine different search strategies.

Once all domain names that match the search criteria using the stored zone file data are located, they are then culled and organized. All duplicates such as “www.compusa.fr”, “www.compusa.de”, and “www.compusa.com” are organized and stored, and then noted in a separate file as only “compusa”. The CCTLD and GTLD indication are dropped, such as “.fr” and/or “.com”.

Thereafter a nameserver query is employed. A nameserver is a computer on the world wide web which reads domain names and correlates them into the corresponding IP Address and then connects the user to the correct site for the domain name. A domain name must be registered in order for the connection to be made. A query is generated to the nameserver for the specific letter/character string, using all of the domain names that match indexed search, such as “compusa”, to the nameserver which is authoritative for a given zone. The nameserver will respond with an effective true or false answer if the queried domain name character string is registered or not registered, in other words, if it can connect to a site or if there is no site to connect to and thus the domain name letter/character string is not registered. The nameserver queries are made in those jurisdictions from which zone file data is incomplete or missing, using the results from indexed list of stored names from the search of public zone files.

For purpose of illustration and not limiting in any manner, if there are 350 “comp” prefixes in the database, the searcher will then perform name server queries for each of the 350 exact domain names known to match the search criteria, not taking into account the CCTLD or GTLD indication.

The apparatus and method can be tuned to balance speed and comprehensiveness. Some non-limiting examples of tuning are adjusting the system so that only the “x” most popular domain names cited in indexed searches are used when doing an nameserver query, where “x” ranges from 1 to the total number of names that match the search request or limiting the number of jurisdictions that are queried or limiting the response time for a nameserver to respond.

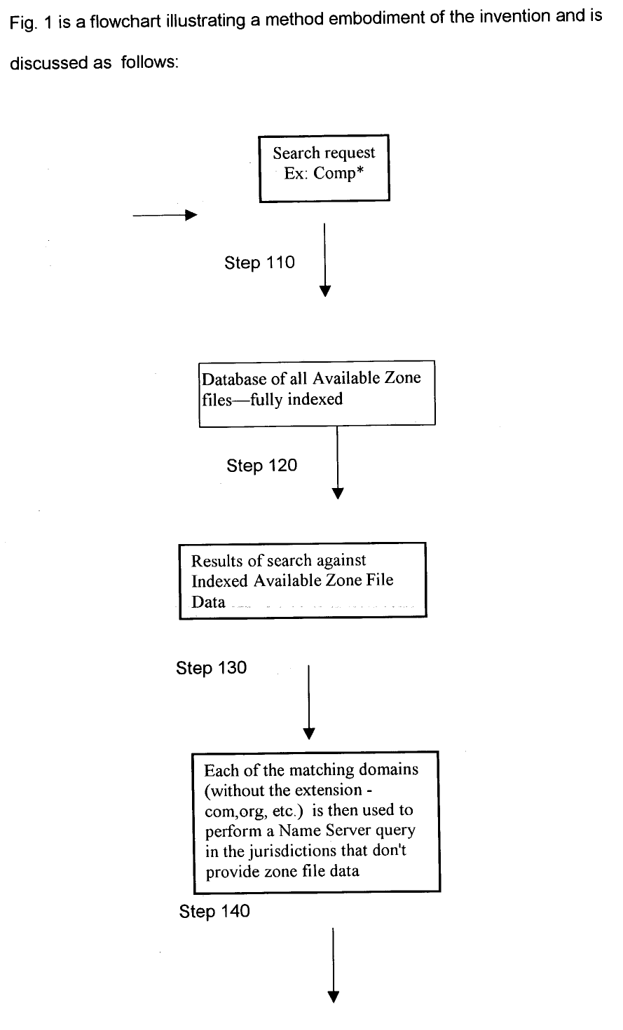

Turning to FIG. 1, which is illustrative of the method of the instant invention, step 110 of the method embodiment of the invention is the input of a search request, in this instant by way of example only, “comp*”. Step 120 illustrates the search request going through the database of all available zone files, which have been previously indexed. Step 130 illustrates the compilation of the results of the first search as generated. Step 140 illustrates how the results of the first search are indexed and then input into a series of new requests to the server in the jurisdictions where no zone file data is made available to the public. Step 150 illustrates the results of the server search and the indexed search are displayed.

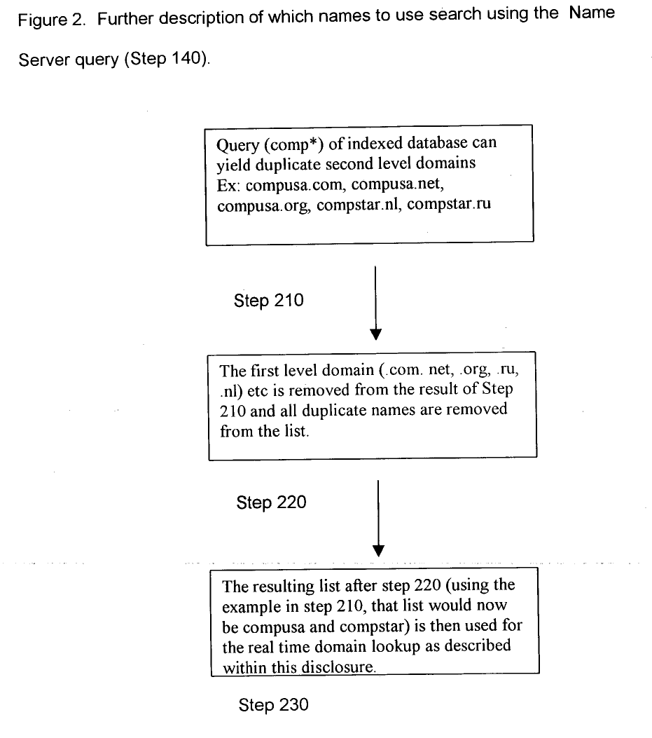

FIG. 2 is illustrative of Step 140 of FIG. 1. Step 210 illustrates the indexing of the results from the world wide search of all zone files in which the variation search may be generated. Following the results of the search, Step 220 illustrates the weeding out process wherein the CCTLD and GTLD indications are dropped and the results are whittled down to general letter/character stings. Each unique letter/character string result of the first search is then queried individually to each of the zone files which are non-public in Step 230.

The method as set forth in FIGS. 1 and 2 can be used for one search or to perform multiple searches periodically for the same letter/character string, such as carrying out a watch service regarding a particular letter/character string. The method is performed for the first time with each letter/character string to generate the baseline search. Subsequent searches are then compared to the baseline search results to determine if new registrations have occurred, or of the domain name has been deleted from a specific registry. If a domain name appears in the subsequent downloaded data, but is not is not part of the baseline search, then it must be a newly registered name. Once a domain name has been deemed new, it is then added to the baseline list, which is now an updated baseline list as of the last search. This updated baseline list is then used as the point of comparison to determine which domain names are ‘new’ as of the latest data download. Such information is valuable to individuals and companies as they can use the information to make an informed decision of whether to pursue a possible infringer of their domain name.

The same methodology, but in reverse, is used to identify deleted domain names.

The methodology can also be used to generate a continuous or recurring query of the jurisdictions that do not supply zone file data using each of the names in the indexed database as the name to be searched using the invention, thus building a global domain database server.

According to one embodiment of the present invention, the method may employ an apparatus comprising a network and may be connected to other systems sharing a common database.

Other embodiments, uses and advantages of the present invention will be apparent to those skilled in the art from consideration of the specification and practice of the invention disclosed herein. The specification and examples should be considered exemplary only.

We claim:

1. A method for searching domain name variations world wide comprising:
(a) searching at least one variation of a letter string in at least one public database;
(b) repeating step (a) in each public database;
(c) generating a result from step (b)
(d) indexing the result such that a CCTLD and GTLD indication is deleted;
(e) searching at least one indexed result in a non-public zone file.

2. The method of claim 1 wherein step (e) is repeated in each non-public zone file.

3. The method of claim 1 further comprising generating a result of the search.

4. The method of claim 1 wherein the variations of the letter string are selected from the group consisting of prefix, suffix and mid-word.

5. A method for searching domain name variations world wide comprising:
(a) searching at least one variation of a letter string in at least one public zone file;
(b) repeating step (a) in each public zone file;
(c) generating a result from step (b)
(d) indexing the result such that a CCTLD and GTLD indication is deleted;
(e) searching at least one indexed result in a non-public zone file.

6. The method of claim 5 wherein step (e) is repeated in each non-public zone file.

7. The method of claim 5 further comprising generating a result of the search.

8. The method of claim 7 wherein the result forms a baseline database.

9. The method of claim 8 wherein a new search is performed monthly and the results are compared with the baseline database.

10. The method of claim 7 wherein the result is logged into a global database.

11. The method of claim 1 wherein the variations of the letter string are selected from the group consisting of prefix, suffix and mid-word.

12. The method of claim 1 wherein step (a) is repeated for each variation.

13. A computer system apparatus comprising
a processor having access to the world wide web;
memory having instructions that when executed by the processor cause the computer system to-perform the steps of:
(a) searching at least one variation of a letter string in at least one public zone file;
(b) repeating step (a) in each public zone file;
(c) generating a result from step (b)
(d) indexing the result such that a CCTLD and GTLD indication is deleted;
(e) searching at least one indexed result in a non-public zone file.

14. The system of claim 13 wherein step (e) is repeated in each non-public zone file.

15. The system of claim 13 further comprising generating a result of the search.

16. The system of claim 15 wherein the result forms a baseline database.

17. The system of claim 16 wherein a new search is performed monthly and the results are compared with the baseline database.

18. The system of claim 13 wherein the result is logged into a global database.

19. The system of claim 13 wherein the variations of the letter string are selected from the group consisting of prefix, suffix and mid-word.

20. The system of claim 13 wherein step (a) is repeated for each variation.
